(19) United States
(12) Patent Application Publication
(10) Pub. No.: US 2009/0048956 A1
(43) Pub. Date: Feb. 19, 2009

(54) Insurance Premium Finance System & Method

(76) Inventor: Donald J. Sprowl, Olathe, KS (US)

Correspondence Address: KUTAK ROCK, LLP, 1801 CALIFORNIA STREET, SUITE 3100, DENVER, CO, 80202-2626, US

(21) Appl. No.: 11/969,855

(22) Filed: Jan. 4, 2008

Related U.S. Application Data
(60) Provisional application No. 60/878,768, filed on Jan. 4, 2007.

(51) Int. Cl. G06Q 40/00

(52) U.S. Cl. 705/35

(57) ABSTRACT

Provided is a system and method for financing insurance policy premiums for an insured unwilling or unable to pay up front the full amount of the insurance premium(s). Critical system and methodology components include eliminating the traditional premium finance company from the process, and establishing a contractual, operational, and financially beneficial relationship between insurance agents and lending institutions (e.g. banks, financial institutions, a lender, or credit unions) identified as premium finance funding companies (PFFCs). The provision of capital, the funding of the policy, and the profit distribution (profit generated from the financing process) are a function of the respective participation of the agent and the PFFC. Servicing of the policy can also be negotiated between the parties. Tools exist (software and otherwise) to assist the PFFC in monitoring agent activities and the management of its capital investments/funding dollars of both the agent and the PFFC.

This application claims priority to U.S. Provisional Patent Application Ser. No. 60/878,768, filed Jan. 4, 2007; the aforementioned application is incorporated herein by reference.

### FIELD OF THE INVENTION

The present invention relates to a method and system for financing the premiums of an insurance policy that an insured elects to finance. More particularly, a method and system for premium financing and funding whereby an individual or entity other than a traditional premium finance company as herein defined, has capital and provides funding, and thereby controls ownership, profits and servicing of the loan associated with the insurance policy.

### BACKGROUND

The financing of insurance policy premiums, for example property-casualty and life insurance policy premiums, is a substantial and robust industry that some experts estimate generates on the order of $156 million of financing transactions each day ($40 billion per year). Traditionally, the principal players in the premium finance market have been the insured, the insurer, the insurance agent, and the premium finance company. Insurance agents have typically given their insurance premium finance business to various premium finance companies with which they have business relationships. However, agents then forego any significant participation in this aspect of the business.

Referring for a moment to FIGS. 1 and 2, the current system of traditional premium financing is outlined in flow chart format. As can be seen from the prior art, the traditional premium finance company (PFC in FIGS. 1 and 2) controls the process and in one instance reaps essentially all of the reward, e.g. profit. The only significant difference between the processes outlined in FIGS. 1 and 2 is that the premium finance company may go to a third party source for capital funding, and therefore be obligated to relinquish ownership and profit to that third party. In this instance, the premium finance company makes its profit by selling the loan, and subsequently servicing the loan for the third party. Under either scenario, the payout to the agent is relatively nominal, if any at all.

Traditional premium finance companies want to stay involved in the lucrative business of premium financing; however, they may not be the most efficient and effective source of financing, and they certainly should not be the sole source. Typically, national and regional premium finance companies, in terms of sources of business, are not community based. There is an opportunity, therefore, for banks and other lending institutions with local ties to a community to tap into the lucrative premium financing market; however, they must understand the variables that drive the business and account for the associated risks.

Historically, premium finance software has been too expensive for an agent to start a premium finance company on his or her own, and the amount of capital required for a line of credit was prohibitive. However, if banks and other lending institutions become involved, it will set the pace and plans for the future. Simply put, a new plan and approach is required focusing on loyalty between agent and lender. Loyalty is closely linked to profits, and profit is the ultimate desired outcome.

Lenders must focus on new and innovative methods to capture agent loyalty, provide agents an opportunity to share more proportionately in the “wealth”, and distribute risk accordingly. Insurance agents are the backbone of the industry, and agents have been making traditional premium finance companies very profitable for many years. Agents are for all intents and purposes the sole source for premium financing. Agents are the commodity. Agents are the single most important element of the premium finance industry, so much so that companies fight for their allegiance. Agents realize this and are able to shop for better rates and terms from company to company. Rates alone, however, have never been, and will never be, the factor that ultimately determines who gets the premium finance business. There are more than 1,200 P&C (property and casualty) carriers with different rates, and each has developed loyal agents. It is a fact, therefore, that the primary reasons for an agent's loyalty lie elsewhere. Lending institutions must confront and must embrace new operating methodologies with a willingness to break traditional operating modes to gain the loyalty of insurance agents.

It is clear, therefore, that a new method, system and approach to financing insurance premiums is required to overcome the issues identified above, maximize opportunity and profit for lending institutions and agents alike, and break the monopolistic grip on the process currently held by traditional premium finance companies.

### SUMMARY

The methods and systems herein disclosed advance the art and overcome problems articulated above by providing a method and system for financing an insurance premium wherein a traditional premium finance company is not involved in the transaction/financing. The traditional premium finance company is defined as a company whose sole purpose is to finance insurance premiums. The insurance agent submits a premium finance agreement (PFA) to the traditional premium finance company which has the capital to fund the insurance policy premium paid to the insurance carrier, and it retains ownership and profit produced from the PFA. Insurance agents have been known to provide capital to fund insurance policies and may be licensed in the same manner as a traditional premium finance company but have never proceeded to the point of completing a relationship with a lender as herein described. Some banks own insurance premium finance companies, and some banks that do not own premium finance companies make loans on insurance policies without advertising themselves as premium finance companies as a service to existing account holders.

In particular, and by way of example only, according to an embodiment, provided is a method for insurance premium financing, including upon drafting an insurance policy for an insured, wherein the insured elects to finance the insurance policy: contracting between the insured and a source of funding for financing the insurance policy, wherein the source of funding is not a traditional premium finance company; obtaining or providing capital necessary to support financing of the insurance policy from at least one capital supplier; funding the insurance policy; delegating ownership of the loan underlying the financed insurance policy, commonly referred to as a premium finance agreement (PFA), and funding the PFA for the source of insurance; disbursing profit proportional to capital supplied for each PFA from the at least one capital supplier; and assigning responsibility for servicing the PFA.

In yet another embodiment, provided is an insurance premium finance system, including: at least one capital supplier necessary for financing the insurance premium of an insurance policy for an insured; a finding and ownership entity; a PFA between the insured and the funding and ownership entity; a plan of PFA profit distribution to the at least one capital supplier, wherein the profit distribution is proportional to a capital contribution for each PFA; and a servicing designee wherein neither the at least one capital supplier nor the funding and ownership entity is a traditional premium finance company.

In still yet another embodiment, provided is a method for insurance premium financing, including: contracting between an insured and a source of funding for financing an insurance policy; obtaining capital necessary to support financing of the insurance policy from a capital supplier; funding the insurance policy; delegating ownership of the insurance policy to the source of funding; disbursing profit to the capital supplier; and assigning responsibility for servicing the PFA.

### BRIEF DESCRIPTION OF THE DRAWINGS

FIG. 1 is a flow chart of a current method for financing the premiums of an insurance policy, as found in the prior art;

FIG. 2 is a flow chart of a current method for financing the premiums of an insurance policy, as found in the prior art;

FIG. 3 is a flow chart of an agent plan for financing the premiums of an insurance policy, according to an embodiment;

FIG. 4 is a flow chart of an agent plan for financing the premiums of an insurance policy, according to an embodiment;

FIG. 5 is a flow chart of an agent plan for financing the premiums of an insurance policy, according to an embodiment; and

FIG. 6 is a flow chart of an agent plan for financing the premiums of an insurance policy, according to an embodiment.

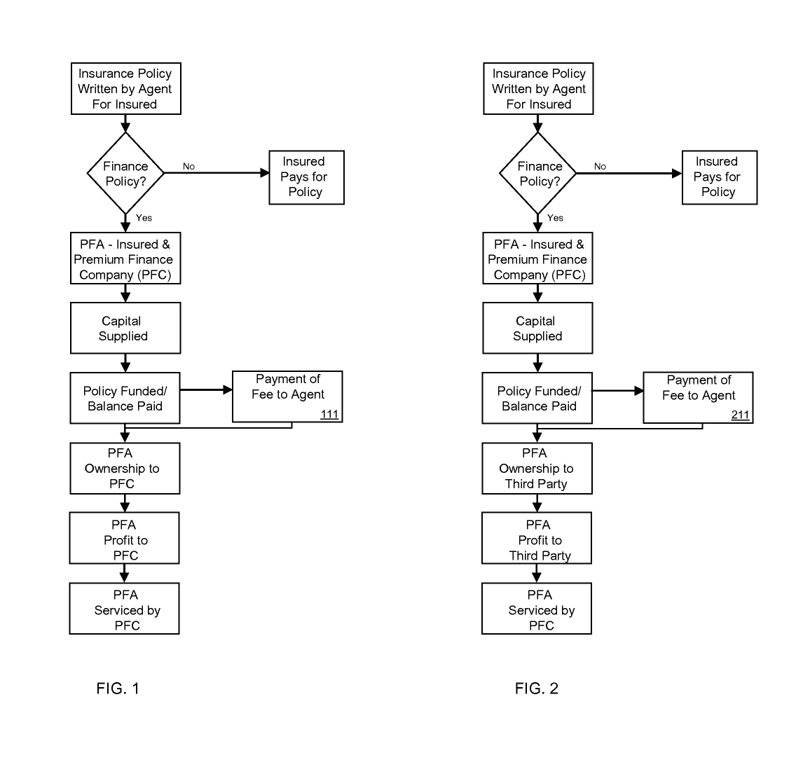

### DETAILED DESCRIPTION

The present disclosure relates to a method and system for financing the premiums of an insurance policy that an insured elects to finance. Importantly, an individual or entity other than a traditional premium finance company provides capital and funding, and thereby controls ownership, profits and servicing of the policy. A cooperative, flexible approach between an insurance agent and a lending institution is disclosed whereby profit is maximized and service to the policy and the insured is ensured

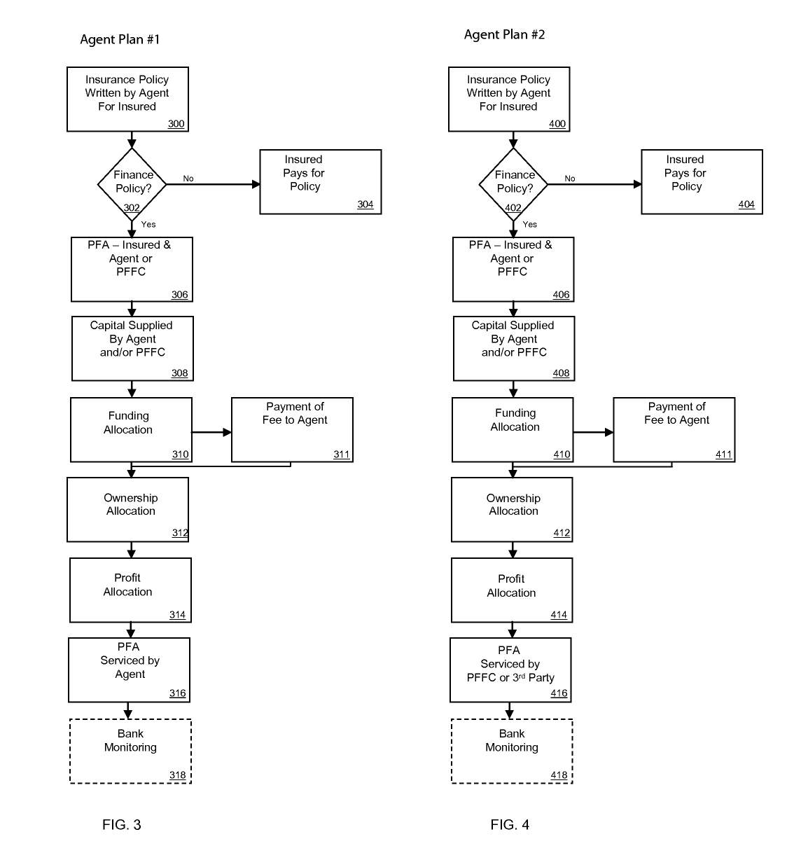

Referring initially to FIG. 3, a new premium finance method, in at least one embodiment designated as “Agent Plan #1”, is summarized in flow chart format. As shown, initially an insurance policy is written or drafted by an insurance agent for an insured (block 300), wherein the insured may be, but is not limited to: an individual, a business, an entity, an organization, a group, a governmental department, or a company. In one or more embodiments, the insurance policy is a property-casualty insurance policy. Substantially concurrent with the drafting or writing of the insurance policy, the insured decides whether to pay for or finance the insurance policy or insurance policy premiums, block 302.

In the event the insured elects to pay for the insurance policy from its own available funds (block 304), no further steps are taken to implement the systems, software programs, and methods disclosed herein. If the insured, however, elects to finance the insurance policy a Loan Contract or Premium Finance Agreement (PFA) is prepared, block 306. The parties to the PFA may be the insured and the insurance agent writing the policy, or alternatively the insured and a lending institution. The lending institution may be, but is not limited to: a bank, a financial institution, a lender, or a credit union, each of which may also be designated a premium finance funding company (PFFC). An insurance agent or an entity owned by an insurance agent may also be a source of funding. In any event, the PFFC is not a traditional premium finance company as that term is generally used and understood in the insurance industry. Financing is typically provided to pay the policy premium minus any down payment paid by the insured. Ultimately, Agent Plan #1 and other plans discussed below may be viewed as a mutual consideration contract “locking” an agent in with one or more PFFCs. Even where no continuing obligation to use the PFFC exists, the agent will most likely continue to do business with the PFFC so long as it is financially and operatively advantageous.

Under Agent Plan #1, there may be one or more suppliers of capital to fund the underlying financing transaction, block 308. In one embodiment, the insurance agent supplies some or all of the necessary capital for each PFA. The PFFC may also supply some or all of the capital for individual PFA'S, depending on the quantity of capital required versus the quantity supplied or made available by the agent for a given portfolio of PFA's. Stated differently, the agent may elect to provide capital, and the agent-provided capital may or may not be sufficient for the subsequent funding of the total number of PFA's. In the event additional capital is needed, beyond the capital supplied by the insurance agent, the PFFC may elect to provide the necessary capital. The decision to use agent-supplied capital or PFFC-supplied capital is made under agreement with the agent and the PFFC, and the agent is not privy to the decision prior to completing the PFA. In this manner, the agent may be motivated to negotiate with the insured a high interest rate, given the agent may be, but is not necessarily, the direct recipient of the financing profit. In at least one embodiment, the capital supply decision is an automated process (software based) driven by known capital accounts and balances. Capital allocation between multiple entities may be done for a PFA.

Once capital is identified and supplied, there must be funding to finance the insurance premiums, which is to say payments or disbursements are made to the insurer (the insurance company providing the policy), block 310. If the insurance agent provides the capital for a given PFA, the agent will fund or pay the balance of policy premiums to the insurance company or managing general agent (MGA) on behalf of the insured. Likewise, if the PFFC provides the capital for a given PFA, the PFFC will fund or pay the balance of policy premiums to the insurance company or MGA on behalf of the insured.

In addition, the PFFC (e.g. a bank) may pay a small fee (i.e. finder's/origination fee) to the insurance agent on each lender capitalized PFA, where allowed by state laws, block 311. This fee is not to be confused with a servicing fee that may be paid to the insurance agent in return for the agent servicing the PFA/policy (as discussed in greater detail below). As with the other Agent Plans, under Agent Plan #1 the agent may be paid a fee for each PFA owned by the PFFC and serviced by the agent, which is separate and distinct from any finder's or origination fee (block 311) the agent may receive. Both fees only relate to the PFA's where the capital and funding is provided by the PFFC.

Still referring to FIG. 3 and Agent Plan #1, ownership of the PFA follows directly from the funding source, block 312. Under Agent Plan #1, if funding is provided by the insurance agent, then ownership rests with the agent as well. Alternatively, if the lender or PFFC is the funding source, it also has ownership of the PFA. Through ownership, the PFFC or bank can create a similar successful relationship that the insurance companies have with their agents. The relationship will be beneficial to both sides. It may be formalized through a contract that spells out mutual consideration creating a business relationship between the PFFC and the agent that will be extraordinarily difficult for any competitor to penetrate. In summary, the insurance agent has complete ownership in PFA's funded solely by the agent, whereas the PFFC has complete ownership in PFA's funded solely by the PFFC. In at least one embodiment, however, the provision of capital and corresponding funding may be divided between an agent and a PFFC for a portfolio of individual PFA's. In that instance, the entity (agent or PFFC) providing the majority of the funding, will have ownership in their respective PFA portfolios.

Just as ownership follows directly from funding, so to does profit distribution flow from capital contribution, block 314. In those cases where the insurance agent provides capital in support of one or more PFA's, the agent receives the entire profit derived from those PFA's. Similarly, if the PFFC is the capital supplier, the PFFC receives the entire profit derived from PFFC supported PFA's. By way of example only, if 40% of the PFA's are funded using capital supplied by the insurance agent, and 60% of the PFA's are funded using capital supplied by the PFFC, then the profit derived from the 40% of PFA's is allocated to the agent, and the profit derived from the 60% of PFA's is allocated to the PFFC.

According to Agent Plan #1, and all of the system and methodologies disclosed herein, there is a servicing designee with responsibility for servicing the PFA, the underlying policy, and/or the insured. Under Agent Plan #1, the insurance agent is the servicing designee regardless of ownership, block 316. In this way, the agent may service his or her own customers. Depending on the PFFC-Agent relationship, there may be a PFFC (e.g. bank)/Agent agreement that specifies the agent's duty and provides for processing to revert to the PFFC in the event the agent fails to perform its duties. Servicing may include, but is not limited to, endorsement, cancellation and reinstatement requests and/or receiving payments from the policyholder (insured) on the PFA. Servicing is a critical element of the insurance policy business, especially as it applies to customer retention and policy renewals. It is important, therefore, to provide the agent an opportunity to service the PFA and related customers, especially in those instances where the agent believes that the service provided by a traditional premium finance company may be inadequate. Agents are generally dissatisfied with service provided to their policyholders by anyone else except the agent.

Policy servicing by an agent is just one reason justifying monitoring (block 318) as an integral part of the Agent Plan #1 methodology. Monitoring is function typically executed by a party independent of the premium financing process, and may refer a plurality of processing activities related to the PFA, to include underwriting, remittances, disbursements, reporting, and balance sheet reconciliation. While this list is indicative of the types of monitoring activities disclosed herein, it is not an exhaustive or exclusive list of monitoring tasks. Specific tasks may be designated by the ownership entity, with or without the knowledge of the other party or parties (e.g. an agent or a PFFC).

A summary table outlining the key elements and options of Agent Plan #1 is provided in Table 1 below. The table is divided between agent owned loans or PFA's and PFFC (e.g. bank, lender) owned loans or PFA's.

TABLE 1

| | | | | |
|---|---|---|---|---|
| Capital | Funding | Ownership | PFA Profit | Servicing |

Agent Plan #1 - Agent Owned Loans/PFA's

| | | | | |
|---|---|---|---|---|
| Agent | Agent | Agent | Agent | Agent |

Agent Plan #1 - PFFC Owned Loans/PFA's

| | | | | |
|---|---|---|---|---|
| PFFC | PFFC | PFFC | PFFC | Agent |

Table 2 provides a “quick look” at the PFFC involvement and commitment to the premium financing process which is the subject of this Agent Plan #1. As shown, the PFFC can quickly implement the plan at a minimal or low cost. The amount of education required to fully qualify a PFFC to participate in, and control as necessary, the process/plan is low. Low also is the amount of plan administration required of the PFFC. Similarly, plan processing is non-existent as the insurance agent is the servicing entity. The ability, opportunity, and desire to conduct independent monitoring (in the face of agent driven policy servicing) is high.

TABLE 2
Agent Plan #1 -PFFC Involvement Summary

| | PFFC | Independent | PFFC | PFFC |
|---|---|---|---|---|
| Implementation | Education | Monitoring | Processing | Administration |
| Speed/Cost | Level | Level | Level | Level |
| Fast/Low | Low | High | None | Low |

Referring now to FIG. 4, yet another embodiment of the present disclosure (designated Agent Plan #2) is provided in flow chart format. A quick comparison of FIGS. 3 and 4 highlights the principal distinction between Agent Plan #1 and Agent Plan #2, to with the servicing entity. As shown, all (blocks 400-414, 418) but the last required step (block 416) of Agent Plan #2 mirror the steps of Agent Plan #1. In accordance with Agent Plan #2, however, the servicing of PFA's is accomplished by the PFFC or by a designated third party. In this one embodiment, ownership is irrelevant as to who will service the policies and corresponding insured. Ownership is relevant, however, with regards to the decision making process as it applies to picking between the PFFC and a third party who services the PFA. Typically, the party having ownership of the PFA will select the means by which the PFA is serviced. Tables 3 and 4 below summarize the principal elements of Agent Plan #2, as well as the PFFC's involvement in the same.

TABLE 3

| | | | | |
|---|---|---|---|---|
| Capital | Funding | Ownership | PFA Profit. | Servicing |

Agent Plan #2 - Agent Owned Loans/PFA's

| | | | | |
|---|---|---|---|---|
| Agent | Agent | Agent | Agent | PFFC or 3^{rd} |
| | | | | Party |

Agent Plan #2 - PFFC Owned Loans/PFA's

| | | | | |
|---|---|---|---|---|
| PFFC | PFFC | PFFC | PFFC | PFFC or 3^{rd} |
| | | | | Party |

TABLE 4
Agent Plan #2 -PFFC Involvement Summary

| | | | | |
|---|---|---|---|---|
| | PFFC | Independent | PFFC | PFFC |
| Implementation | Education | Monitoring | Processing | Administration |
| Speed/Cost | Level | Level | Level | Level |

PFFC services the PFA's

| | | | | |
|---|---|---|---|---|
| Fast/Medium | Medium | None | High | High |

Third party services the PFA's

| | | | | |
|---|---|---|---|---|
| Fast/Medium | Low | High | None | Low |

Of note, PFFC required education levels, processing levels and administration levels are higher than under Agent Plan #1. This is primarily driven by the possibility of the PFFC servicing of PFA's, or alternatively, a third party servicing requiring greater PFFC oversight. By contrast, however, the independent monitoring function is not required as the PFFC is intimately involved in all aspects of the plan/process.

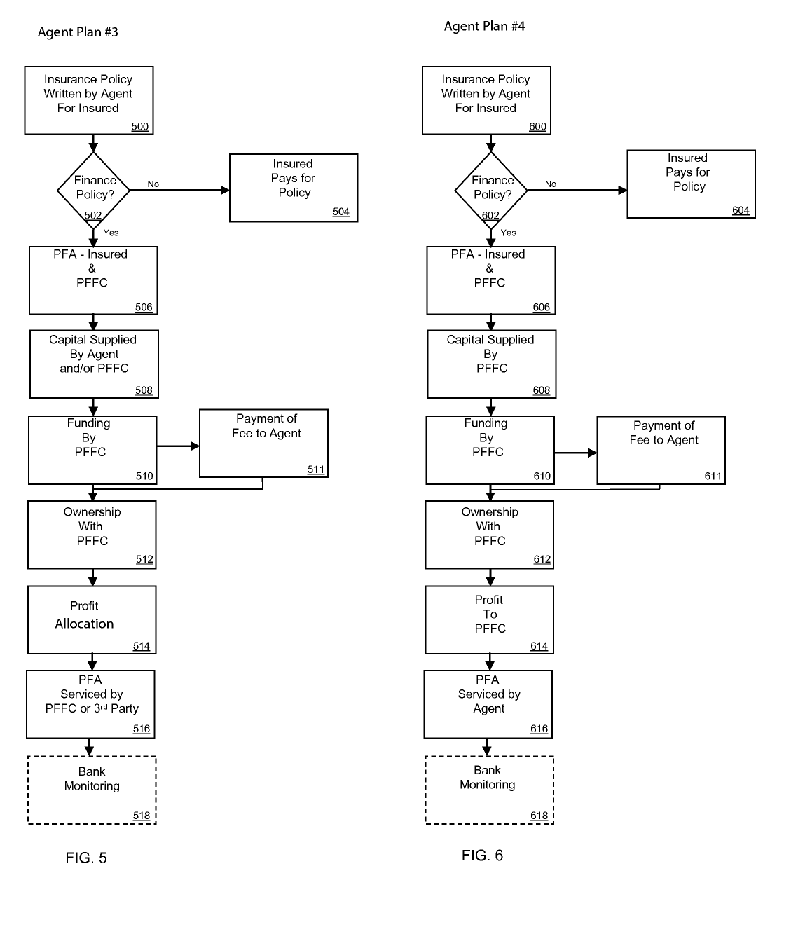

Cross-referencing for a moment FIG. 3 and FIG. 5, it can be seen that the two plans (Agent Plan #1 in FIG. 3 and Agent Plan #3 in FIG. 5) differ with regard to agent supplied capital and related funding. Under Agent Plan #1, it is possible for the insurance agent to be the supplier of capital for some or all of the PFA's created. It is not ever possible, however, under Agent Plan #3 for the agent to be the funding source or owner. This distinction is driven primarily by statutory limitations placed on agents requiring licensing in certain states. Accordingly, under Agent Plan #3, agents may establish accounts at the PFFC, the funds in which may be used as collateral funding of PFA's by the PFFC. Regardless, the PFFC is always the funding source (block 510 in FIG. 5). Profit is still allocated and distributed based on the account deposits of the agent and the PFFC (block 514), and the agent may still be paid an origination or finder's fee for each PFFC capitalized PFA, where allowed by state law (block 511). Most of the remaining steps of Agent Plan #3 (blocks 500-508, 512, 514 and 518) are also essentially the same as Agent Plan #1, to include the fact that PFFC funded PFA's, using PFFC supplied capital, result in ownership and profit distribution solely to the PFFC. One further distinction between Agent Plan #1 and Agent Plan #3 is that PFA servicing (block 516) is accomplished by either the PFFC or a third party (ala Agent Plan #2). As with Agent Plans #1 and 2 above, summary tables (Tables 5 and 6) outline the key elements of this embodiment of the present disclosure.

TABLE 5
Agent Plan #3 - Agent Account Deposits/Collateral

| Account | | | | |
|---|---|---|---|---|
| Deposits | Funding | Ownership | PFA Profit. | Servicing |
| Agent | PFFC | PFFC | Agent | PFFC |

Agent Plan #3 - PFFC Owned Loans/PFA's

| Capital | Funding | Ownership | PFA Profit. | Servicing |
|---|---|---|---|---|
| PFFC | PFFC | PFFC | PFFC | PFFC |

TABLE 6
Agent Plan #3 -PFFC Involvement Summary

| | | | | |
|---|---|---|---|---|
| | PFFC | Independent | PFFC | PFFC |
| Implementation | Education | Monitoring | Processing | Administration |
| Speed/Cost | Level | Level | Level | Level |

PFFC services the PFA's

| | | | | |
|---|---|---|---|---|
| Fast/Medium | Medium | None | High | High |

Third party services the PFA's

| | | | | |
|---|---|---|---|---|
| Fast/Medium | Low | High | None | Low |

As shown in FIG. 6, the role of the insurance agent is minimized in that the agent is not a supplier of capital nor source of funding (blocks 608 and 610). As such, the agent does not have ownership of the PFA (block 612) nor does he or she receive profit from the financing operation (block 614). The agent still is responsible for drafting or writing the policy for the insured (block 600), and perhaps most importantly the agent is assigned the responsibility for servicing the PFA (block 616). As with the other Agent Plans, under Agent Plan #4 the agent may be paid a fee for each PFA owned by the PFFC and serviced by the agent, which is separate and distinct from any finder's or origination fee (block 611) the agent may receive. Further, the PFFC (bank, lender, etc.) still has the option of monitoring one or more processing related activities using provided software tools or other monitoring methods selected by the PFFC (block 618). This embodiment, as disclosed in FIG. 6 and summarized below, provides the agent the flexibility to service the PFA's and to profit in some manner from the financial success of the insurance premium financing methods disclosed herein, without requiring a commitment of capital which the agent may or may not possess. Agent Plan #4 is summarized in the tables below.

TABLE 7
Agent Plan #4 - PFFC Owned Loans/PFA's

| Capital | Funding | Ownership | PFA Profit. | Servicing |
|---|---|---|---|---|
| PFFC | PFFC | PFFC | PFFC | Agent |

TABLE 8
Agent Plan #4 -PFFC Involvement Summary

| | PFFC | Independent | PFFC | PFFC |
|---|---|---|---|---|
| Implementation | Education | Monitoring | Processing | Administration |
| Speed/Cost | Level | Level | Level | Level |
| Fast/Low | Low | High | None | Low |

While shown and described above as a series of methods for insurance premium financing, it can be appreciated by those skilled in the art that a system for accomplishing the same is also disclosed herein. Specifically, a system for providing insurance premium financing may include: at least one capital supplier necessary for financing the insurance premium of an insurance policy for an insured; a funding and ownership entity; a premium finance agreement (PFA) between the insured and the funding and ownership entity; a plan of PFA profit distribution to the at least one capital supplier, and a servicing designee. As with the methodologies disclosed above, the profit distribution is proportional to a capital contribution and neither the at least one capital supplier nor the funding and ownership entity is a traditional premium finance company. Alternatively, the source of funding may be either an insurance agent or a PFFC. Similarly, the capital source may also be one of these two entities.

The system of the present disclosure may also include software packages or subsystems to support critical system functions such as managing premium finance receivables, providing educational tools, training, monitoring system related processing activities, controlling premium financing by funding and ownership entities, auditing accounts, servicing loans, assessing risk, identifying customers, facilitating regulatory compliance, debit-credit accounting generating forms, and compiling and reporting data. This list is not intended to be exhaustive or exclusive, and it can be appreciated that other software functions supportive of insurance premium financing may be included without departing from the scope and intent of this disclosure.

The system may also include one or more monitoring instruments for monitoring system related processing activities. The system related processing activities, as discussed above, may include but are not limited to underwriting, remittances, disbursements, reporting, and balance sheet reconciliations. One or more of these activities may be automated.

The benefits and advantages of the methodologies and systems disclosed herein are significant. For the insurance agent it provides a means by which the agent may invest its capital and participate in the funding process. Financially this helps to ensure the agent shares in the profits generated from insurance premium financing. The agent may still receive many of the fees (e.g. finder's/origination) previously available, as well as fees for servicing the PFA/insurance policy. PFA servicing allows the agent to manage and control the quality of service provided his or her customers. The PFFC (e.g. the bank) benefits by becoming involved in an industry that previously was monopolized by traditional premium finance companies. Many of the state rules and regulations applicable to premium finance companies do not apply to PFFCs, including but not limited to, national banks, therefore the PFFC can provide maximum flexibility and return on the capital investment. The PFFC/Agent relationship creates a new pool of loyal customers (agents) that are willing and able to deposit their moneys with the PFFC, as well as tell their customers to do the same. The risk of bad debt realization is minimal as the PFFC can rely on regulatory support on PFA defaults.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which as a matter of language, might be said to fall therebetween.

What is claimed:

1. A method for insurance policy premium financing, comprising:
contracting between an insured and an agent for an insurance policy;
creating a premium financing agreement, wherein the insured elects to finance the insurance policy premiums;
contracting between the insured and a source of funding for financing the insurance policy premiums, wherein the source of funding is not a traditional premium finance company;
entering into an agreement between the agent and the source of funding to provide capital necessary to support financing of the premium financing agreement from at least one capital supplier;
funding the insurance policy;
delegating ownership of the insurance policy and funding contract to the source of funding;
disbursing profit to capital supplied from the at least one capital supplier; and
assigning responsibility for servicing the insurance policy.

2. The method of claim 1, wherein the source of funding is a selected from a group consisting of: an agent and a premium finance funding company.

3. The method of claim 2, wherein the premium finance funding company is selected from a group consisting of: an agent-owned funding source, a bank, a financial institution, a lending institution, and a credit union.

4. The method of claim 1, wherein the at least one capital supplier is selected from a group consisting of: an agent and a premium finance funding company.

5. The method of claim 4, wherein the premium finance funding company is selected from a group consisting of: an agent-owned funding source, a bank, a financial institution, a lending institution, and a credit union.

6. The method of claim 1, wherein there are multiple capital suppliers for a portfolio of premium finance agreements, and further wherein a pro rata distribution of profit is made to each of the multiple capital suppliers in proportion to the capital supplied to each portfolio.

7. The method of claim 1, further comprising paying fees to the insurance agent.

8. The method of claim 7 wherein the fees are a finder's fee.

9. The method of claim 7 wherein the fees are a service fee.

10. The method of claim 1, further comprising independent monitoring of the processing of the agreement between the agent and the source of funding and the premium financing agreement.

11. The method of claim 10, wherein the one or more processing activities are selected from a group consisting of: underwriting, remittances, disbursements, reporting, and balance sheet reconciliation.

12. The method of claim 1, wherein the insurance agent is assigned responsibility for servicing the insurance policy.

13. An insurance premium finance system, comprising:
at least one capital supplier necessary for financing the insurance premium of an insurance policy for an insured;
a funding and ownership entity;
a premium finance agreement between the insured and the funding and ownership entity;
a plan of premium financing agreement profit distribution to the at least one capital supplier, wherein the profit distribution is proportional to a capital contribution; and
a premium financing agreement servicing designee
wherein neither the at least one capital supplier nor the funding and ownership entity is a traditional premium finance company.

14. The system of claim 13, further comprising a monitoring instrument for monitoring system related processing activities.

15. The system of claim 14, wherein the system related processing activities are selected from a group consisting of: underwriting, remittances, disbursements, reporting, agent activities, and balance sheet reconciliation.

16. The system of claim 13, wherein the at least one capital supplier is selected from a group consisting of: an agent-owned funding source, a bank, a financial institution, a lending institution, and a credit union.

17. The system of claim 13, wherein the funding and ownership entity is selected from a group consisting of: an agent-owned funding source, a bank, a financial institution, a lending institution, and a credit union.

18. The system of claim 13, further comprising a software package, wherein the software package performs functions selected from a group consisting of: managing premium finance receivables; providing educational tools; training; monitoring system related processing activities; controlling premium financing by funding and ownership entities; auditing accounts; servicing loans; assessing risk; identifying customers; facilitating regulatory compliance; debit-credit accounting; generating forms; and compiling and reporting data.

19. A method for insurance policy premium financing, comprising:
contracting between an insured and a source of funding for financing an insurance policy;
obtaining capital necessary to support financing of the insurance policy from a capital supplier;
funding the insurance policy;
delegating ownership of the insurance policy to the source of funding;
disbursing profit to the capital supplier; and
assigning responsibility for servicing the insurance policy.

20. The method of claim 19, wherein the source of funding and the capital supplier are an insurance agent-owned funding source.

21. The method of claim 19, wherein the source of funding and the capital supplier are a premium finance funding company.

22. The method of claim 19, wherein the responsibility for servicing the insurance policy is assigned to an insurance agent.

23. The method of claim 19, wherein the responsibility for servicing the insurance policy is assigned to a premium finance funding company.

24. The method of claim 19, wherein the responsibility for servicing the insurance policy is assigned to a third party.

25. The method of claim 19, wherein the capital supplier is an insurance agent-owned funding source and the source of funding is a premium finance funding company.

26. The method of claim 19, further comprising paying an insurance agent additional fees.

27. The method of claim 26 wherein the fees are a finder's fee.

28. The method of claim 26 wherein the fees are a service fee.

29. The method of claim 19, further comprising monitoring one or more processing activities related to a premium financing agreement.
